(19) United States
(12) Patent Application Publication
(10) Pub. No.: US 2026/0328414 A1
(43) Pub. Date: Oct. 22, 2026

(54) AIR CONDITIONER

(71) Applicant: QINGDAO HISENSE HITACHI AIR-CONDITIONING SYSTEMS CO., LTD., Shandong (CN)

(72) Inventors: Haonan WANG, Qingdao (CN); Yixin JIANG, Xi'an (CN); Xiaomin LIU, Xi'an (CN)

(73) Assignee: QINGDAO HISENSE HITACHI AIR-CONDITIONING SYSTEMS CO., LTD., Shandong (CN)

(21) Appl. No.: 19/634,056

(22) Filed: Mar. 30, 2026

Related U.S. Application Data
(63) Continuation of application No. PCT/CN2024/087006, filed on Apr. 10, 2024.

(30) Foreign Application Priority Data
Oct. 18, 2023 (CN) 202311354680.2
Oct. 18, 2023 (CN) 202322803580.5

(51) Int. Cl. F24F 1/38; F24F 1/56

(52) U.S. Cl. CPC F24F 1/38; F24F 1/56

(57) ABSTRACT

An air conditioner includes an outdoor unit. The outdoor unit includes a fan. The fan includes a motor and a fan blade. The fan blade includes a connecting portion and at least one blade. The at least one blade is connected to the connecting portion. The at least one blade includes a first edge portion, and the first edge portion is arranged on the side of the at least one blade away from the connecting portion. The distance between the end of the first edge portion close to a windward side of the at least one blade and the axis of the connecting portion is greater than the distance between the end of the first edge portion close to a leeward side of the at least one blade and the axis of the connecting portion.

### CROSS REFERENCE TO THE RELATED APPLICATIONS

This application is a continuation of International Patent Application No. PCT/CN2024/087006 filed on Apr. 10, 2024, which claims priority to Chinese Patent Application No. 202322803580.5 filed on Oct. 18, 2023, and Chinese Patent Application No. 202311354680.2 filed on Oct. 18, 2023, the entire contents of which are incorporated herein by reference.

### TECHNICAL FIELD

The present disclosure relates to the field of air conditioning technologies, and in particular, to an air conditioner.

### RELATED ART

An air conditioner is a device that can regulate and control the temperature, humidity and circulating air of the ambient air in buildings or structures. An air conditioner includes a heat exchanger, which can be installed in either the indoor unit or outdoor unit of the air conditioner. Through the rotation of a fan, air is driven to flow through the heat exchanger, so that the heat exchanger can exchange heat with the surrounding environment.

### SUMMARY OF INVENTION

An air conditioner is provided. The air conditioner includes an outdoor unit. The outdoor unit includes a casing, and a fan. The casing includes a mounting cavity. The fan is arranged in the mounting cavity. The fan includes a motor and a fan blade. The fan blade includes a connecting portion and at least one blade. The fan blade is connected to an output portion of the motor via the connecting portion. The at least one blade is connected to the connecting portion and spaced apart along a circumferential direction of the connecting portion. The at least one blade includes a first edge portion. The first edge portion is disposed on a side of the at least one blade away from the connecting portion. The first edge portion includes a first sub-edge portion, a second sub-edge portion, and a third sub-edge portion. The first sub-edge portion is disposed at an end of the first edge portion that is close to a windward side of the at least one blade. The second sub-edge portion is disposed at an end of the first edge portion that is close to a leeward side of the at least one blade. The third sub-edge portion is connected between the first sub-edge portion and the second sub-edge portion. A distance between an end of the first sub-edge portion that is close to a windward side of the at least one blade and an axis of the connecting portion is greater than a distance between an end of the second sub-edge portion that is close to a leeward side of the at least one blade and the axis of the connecting portion.

### BRIEF DESCRIPTION OF DRAWINGS

FIG. 1 is a structural diagram of an air conditioner according to some embodiments;

FIG. 2 is another structural diagram of the air conditioner according to some embodiments;

FIG. 3 is a structural diagram of an outdoor unit according to some embodiments;

FIG. 4 is another structural diagram of the outdoor unit according to some embodiments;

FIG. 5 is a structural diagram of a fan blade and a casing according to some embodiments;

FIG. 6 is a structural diagram of the fan blade according to some embodiments;

FIG. 7 is a structural diagram of the fan blade and an air guide portion according to some embodiments;

FIG. 8 is a partial enlarged view of circle A in FIG. 7;

FIG. 9 is a sectional view taken along line B-B in FIG. 7;

FIG. 10 is a partial enlarged view of circle C in FIG. 9;

FIG. 11 is a structural diagram of a connecting portion and a blade according to some embodiments;

FIG. 12 is another structural diagram of the connecting portion and the blade according to some embodiments;

FIG. 13 is a line graph showing a relationship between an air quantity and a rotating speed of the fan according to some embodiments;

FIG. 14 is a line graph showing a relationship between noise and a rotating speed of the fan according to some embodiments;

FIG. 15 is a line graph showing a relationship between noise and air quantity of the fan according to some embodiments;

FIG. 16 is a line graph showing a relationship between a power consumption and air quantity of the fan according to some embodiments;

FIG. 17 is a structural diagram of another fan blade and air guide portion according to some embodiments;

FIG. 18 is a structural diagram of the another fan blade according to some embodiments;

FIG. 19 is a structural diagram of the another air guide portion according to some embodiments;

FIG. 20 is another structural diagram of the another fan blade and air guide portion according to some embodiments;

FIG. 21 is a sectional view taken along line Q-Q in FIG. 20;

FIG. 22 is a partial enlarged view of circle W in FIG. 21;

FIG. 23 is a line graph showing a relationship between an air quantity and a rotating speed of the another fan according to some embodiments;

FIG. 24 is a line graph showing a relationship between noise and the rotating speed of the another fan according to some embodiments;

FIG. 25 is a line graph showing a relationship between the noise and the air quantity of the another fan according to some embodiments; and

FIG. 26 is a line graph showing a relationship between power consumption and the air quantity of another fan according to some embodiments.

### DESCRIPTION OF EMBODIMENTS

Some embodiments of the present disclosure are clearly and completely described below with reference to the accompanying drawings, and apparently, the described embodiments are not all but only a part of the embodiments of the present disclosure. All other embodiments obtained by a person of ordinary skill in the art based on the embodiments of the present disclosure shall fall within the protection scope of the present disclosure.

The use of “adapted to” or “configured for” herein means open and inclusive languages and does not exclude devices adapted to or configured for performing additional tasks or steps.

Unless required otherwise in the context, throughout the specification and the claims, the term “comprise” and its other forms such as “comprises” and “comprising” are interpreted as open and inclusive meaning “including, but not limited to”. In the description of the specification, the terms “one embodiment”, “some embodiments”, “exemplary embodiments”, “example”, “specific example”, “some examples”, or the like, are intended to indicate that a particular feature, structure, material, or characteristic in connection with the embodiment or example is included in at least one embodiment or example of the present disclosure. The schematic representations of the above terms do not necessarily refer to the same embodiment or example. In addition, the particular feature, structure, material, or characteristic may be included in any suitable manner in any one or more embodiments or examples.

Hereinafter, the terms such as “first” and “second” are used herein for purposes of description and are not intended to indicate or imply relative importance or significance or to imply the number of indicated technical features. Thus, the feature defined with “first” and “second” may include one or more of this feature explicitly or implicitly. In the description of the embodiments of the present disclosure, “a plurality” means two or more unless otherwise specified.

In the description of the present disclosure, it should be understood that the terms “center”, “upper”, “lower”, “front”, “rear”, “left”, “right”, “vertical”, “horizontal”, “top”, “bottom”, “inner”, “outer”, etc., indicate the orientation or positional relationship as shown in the accompanying drawings. They are used for the convenience of describing the present disclosure and simplifying the description, and do not indicate or imply that the described device or element must have a specific orientation, or be constructed and operated in a specific orientation. Therefore, these terms should not be construed as limitations on the present disclosure.

In describing some embodiments, the expressions “coupled” and “connected” along with their derivatives may be used. For example, the term “connecting” may be used when describing some embodiments to indicate that two or more components are in direct physical or electrical contact with each other. For example, the term “coupled” may be used when describing some embodiments to indicate that two or more components have direct physical or electrical contact. However, the terms “coupled” or “communicatively coupled” may also refer to two or more components that do not have direct contact with each other but still cooperate or interact with each other. The embodiments disclosed herein are not necessarily limited to the content herein.

An air conditioner, which is a relatively common household appliance, is widely used in daily life. As shown in FIG. 1, in some embodiments, the air conditioner 100 includes an outdoor unit 200 and an indoor unit 300. The indoor unit 300 includes an indoor heat exchanger. The outdoor unit 200 includes an outdoor heat exchanger, an outdoor fan, and a compressor. The air conditioner 100 regulates the indoor air temperature through the cooperation of the outdoor unit 200 and the indoor unit 300.

The air conditioner 100 further includes an expansion valve configured to regulate a flow rate of the refrigerant within the refrigerant pipe of the air conditioner 100.

The air conditioner further includes a fan, which may be installed in either the outdoor unit or the indoor unit and is configured to assist in temperature regulation. In the case that the fan is installed in the outdoor unit, it is configured to promote heat exchange between the refrigerant flowing in the heat transfer tubes of the outdoor heat exchanger and the outdoor air. In the case that the fan is installed in the indoor unit, it is configured to facilitate heat exchange between the refrigerant flowing in the heat transfer tubes of the indoor heat exchanger and the indoor air. For example, the fan is an axial flow fan.

The axial flow fan includes a motor and fan blades. It should be noted that the axial flow fan refers to a fan in which air flows along the length of the rotational axis of the fan blades when the fan blades are running. During the operation of the axial flow fan, there is a gap between the fan blades and the casing of the outdoor unit or indoor unit, causing the high-pressure airflow on the side of the fan blades away from the motor to leak through this gap, thereby reducing the air delivery efficiency of the axial flow fan.

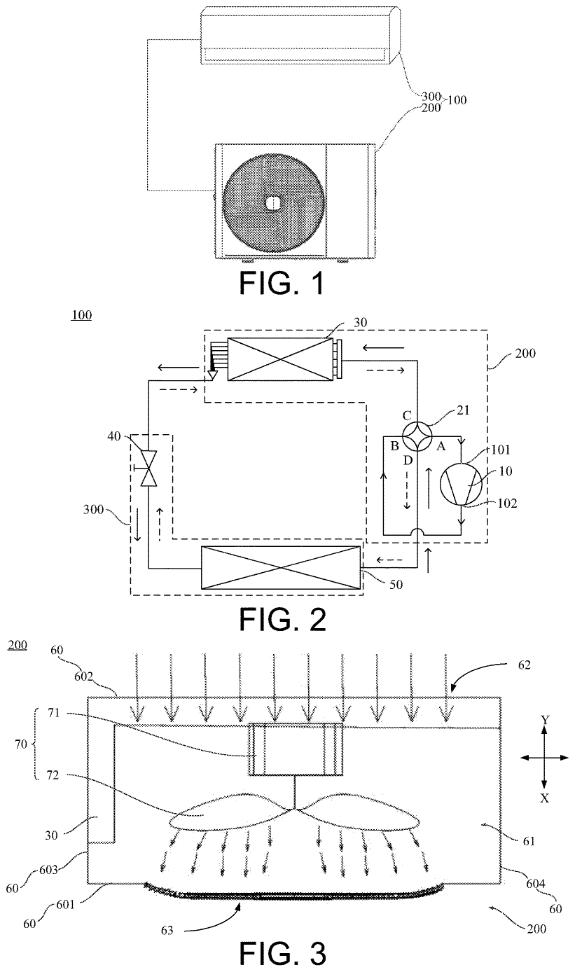

To solve the above problems, the present disclosure provides an air conditioner 1000. In some embodiments, as shown in FIG. 2, the air conditioner 1000 includes an outdoor unit 200 and an indoor unit 300.

The air conditioner 100 further includes a compressor 10, and the compressor 10 is arranged in the outdoor unit 200, for example. The compressor 10 includes a suction port 101 and a discharge port 102. The compressor 10 is configured to suck the low-temperature and low-pressure gas-phase refrigerant from the suction port 101, compress the gas-phase refrigerant in the low-temperature and low-pressure state by driving a piston via a motor, and then discharge the high-temperature and high-pressure gas-phase refrigerant through the discharge port 102, so that the compressor 10 can provide power for a cooling cycle.

In some embodiments, the air conditioner 1000 further includes an indoor heat exchanger 50, which is arranged, for example, in the indoor unit 300. The indoor heat exchanger 50 performs one of liquefaction or vaporization of the refrigerant by exchanging heat between the indoor air and the refrigerant flowing within the indoor heat exchanger 50.

In some embodiments, the air conditioner 1000 further includes an outdoor heat exchanger 30, which is arranged, for example, in the outdoor unit 200. The outdoor heat exchanger 30 is configured to perform the other one of liquefaction or vaporization of the refrigerant by exchanging heat between the outdoor air and the refrigerant flowing within the outdoor heat exchanger 30.

The compressor 10, the condenser (the indoor heat exchanger 50 or the outdoor heat exchanger 30), the expansion valve, and the evaporator (the outdoor heat exchanger 30 or the indoor heat exchanger 50) execute the refrigerant cycle of the air conditioner 100. The refrigerant cycle includes a series of processes involving compression, condensation, expansion, and evaporation, and circulates and supplies the refrigerant to the conditioned side.

In some embodiments, the air conditioner 1000 further includes a four-way valve 21, and the four-way valve 21 is arranged in the outdoor unit 200, for example. The four-way valve 21 includes a first port A, a second port B, a third port C, and a fourth port D. The first port A of the four-way valve 21 is communicated with the suction port 101 of the compressor 10, the second port B is communicated with the discharge port 102 of the compressor 10, the third port C is communicated with the outdoor heat exchanger 30, and the fourth port D is communicated with the indoor heat exchanger 50.

In some embodiments, the air conditioner 1000 further includes a pressure reducer 40. The pressure reducer 40 is arranged between the indoor heat exchanger 50 and the outdoor heat exchanger 30, and configured to reduce a pressure of a high-pressure gas-phase refrigerant in a refrigerant pipe to form a low-pressure gas-phase refrigerant and maintain a stable pressure and a stable flow rate of the output gas-phase refrigerant, so as to ensure stable operation of the air conditioner 1000.

In some embodiments, as shown in FIG. 3, the outdoor unit 200 includes a casing 60. The casing 60 defines a mounting cavity 61, and the outdoor heat exchanger 30 is arranged in the mounting cavity 61.

In some embodiments, the casing 60 includes at least one air inlet 62, and the at least one air inlet 62 communicates the mounting cavity 61 with an external environment. The outdoor heat exchanger 30 is arranged adjacent to the at least one air inlet 62.

In some embodiments, the casing 60 further includes an air outlet 63, and the air outlet 63 communicates the mounting cavity 61 with the external environment.

In some embodiments, the air conditioner 1000 further includes a fan 70, and the fan 70 is arranged in the mounting cavity 61 of the outdoor unit 200 and near the air outlet 63, for example. The fan 70 includes a motor 71 and a fan blade 72. The fan blade 72 is connected, for example, to an output portion of the motor 71, so that the motor 71 drives the fan blade 72 to rotate. The fan 70 is, for example, an axial flow fan.

The airflow enters the mounting cavity 61 through the air inlet 62, and after exchanging heat with the refrigerant transported in the outdoor heat exchanger 30 in the mounting cavity 61 under driving of the fan 70, the airflow flows out of the outdoor unit 200 through the air outlet 63. In this case, a negative pressure region is formed inside the mounting cavity 61, and air outside the casing 60 can flow into the mounting cavity 61 through the air inlet 62, thereby forming a heat exchange cycle of the outdoor unit 200.

In some embodiments, as shown in FIG. 3, the casing 60 further includes a first plate 601, a second plate 602, a third plate 603, and a fourth plate 604. In the case where the air outlet 63 is arranged on the first plate 601 of the casing 60, the at least one air inlet 62 may be arranged on at least one of the second plate 602, the third plate 603, or the fourth plate 604. In this case, an axis of the fan 70 is, for example, parallel to a first direction (e.g., front-rear direction of the casing 60) or a second direction (e.g., left-right direction of the casing 60).

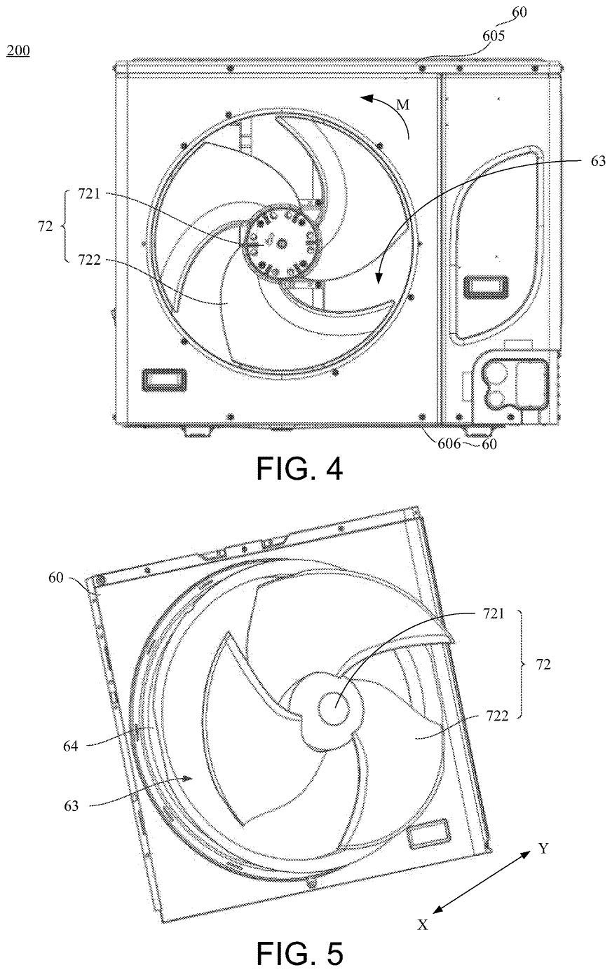

In some embodiments, as shown in FIG. 4, the casing 60 further includes a fifth plate 605 and a sixth plate 606. The fifth plate 605 is arranged corresponding to the sixth plate 606, and is connected to the first plate 601, the second plate 602, the third plate 603, and the fourth plate 604. In the case where the air outlet 63 is arranged on the fifth plate 605, the at least one air inlet 62 may be arranged on at least one of the first plate 601, the second plate 602, the third plate 603, or the fourth plate 604. In this case, the axis of the fan 70 is, for example, parallel to a third direction (e.g., up-down direction of the casing 60).

In some embodiments, as shown in FIG. 4, the fan blade 72 includes a connecting portion 721, and the fan blade 72 is connected to the output portion of the motor 71 through the connecting portion 721.

In some embodiments, as shown in FIG. 4, the fan blade 72 further includes at least one blade 722, and the at least one blade 722 is connected to the connecting portion 721. In the case where the at least one blade 722 includes a plurality of blades 722, the plurality of blades 722 are arranged at intervals in a circumferential direction of the connecting portion 721.

In some embodiments, assuming that the at least one blade 722 includes n blades 722, n being a natural number greater than or equal to 2, the n blades 722 may be spaced apart by a central angle of 360°/n in the circumferential direction of the connecting portion 721, so that stability of the fan blade 72 during rotation may be ensured. For example, in the case where the at least one blade 722 includes two blades 722, the two blades 722 may be spaced apart by a central angle of 180° in the circumferential direction of the connecting portion 721. For another example, in the case where the at least one blade 722 includes three blades 722, the three blades 722 may be spaced apart by a central angle of 120° in the circumferential direction of the connecting portion 721. For another example, in the case where the at least one blade 722 includes four blades 722, the four blades 722 may be spaced apart by a central angle of 90° in the circumferential direction of the connecting portion 721.

In some embodiments, a side of the fan blade 72 away from the motor 71 is defined as a front side (X direction in FIG. 3), and a side close to the motor 71 is defined as a rear side (Y direction in FIG. 3). In the case where the fan blade 72 rotates counterclockwise (M direction in FIG. 4), since the fan 70 delivers the airflow from the side of the fan blade 72 close to the motor 71 to the side thereof away from the motor 71, a high-pressure airflow region is formed at the side of the blade 722 of the fan blade 72 away from the motor 71, and a low-pressure region is formed at the side of the blade 722 of the fan blade 72 close to the motor 71.

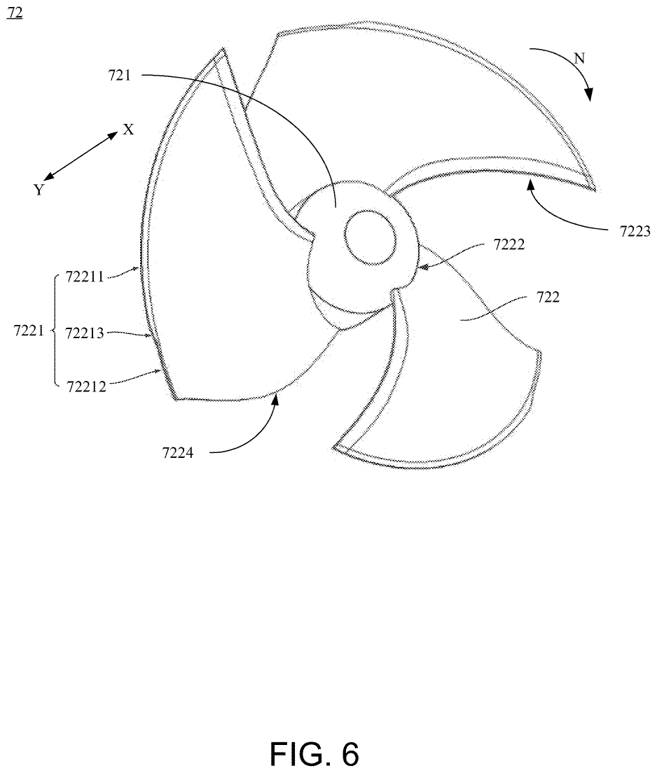

In some embodiments, as shown in FIG. 6 and FIG. 8, the at least one blade 722 includes a first edge portion 7221, the first edge portion 7221 being arranged on a side of the at least one blade 722 away from the connecting portion 721. A distance between an end of the first edge portion 7221 close to a windward side of the at least one blade 722 and an axis of the connecting portion 721 is greater than a distance between an end of the first edge portion 7221 close to a leeward side of the at least one blade 722 and the axis of the connecting portion 721.

In some embodiments, the at least one blade 722 further includes a second edge portion 7222. The second edge portion 7222 is arranged on a side of the at least one blade 722 close to the connecting portion 721, and the at least one blade 722 is connected to the connecting portion 721 via the second edge portion 7222.

In some embodiments, the at least one blade 722 further includes a third edge portion 7223. The third edge portion 7223 is arranged between the first edge portion 7221 and the second edge portion 7222, and the third edge portion 7223 is arranged on the windward side of the at least one blade 722. That is, in the case where the fan blade 72 rotates clockwise (N direction in FIG. 6), between the first edge portion 7221 and the second edge portion 7222, a side of the at least one blade 722 facing the windward side is the third edge portion 7223. The windward side of the at least one blade 722 is, for example, a side thereof facing the at least one air inlet 62.

In some embodiments, the at least one blade 722 further includes a fourth edge portion 7224. The fourth edge portion 7224 is arranged between the first edge portion 7221 and the second edge portion 7222, and the fourth edge portion 7224 is arranged on the leeward side of the at least one blade 722. That is, in the case where the fan blade 72 rotates clockwise, between the first edge portion 7221 and the second edge portion 7222, a side of the at least one blade 722 facing the leeward side is the fourth edge portion 7224. The leeward side of the at least one blade 722 is, for example, a side thereof facing the air outlet 63.

In some other embodiments, along a circumferential direction of the fan blade 72, a side of the at least one blade 722 facing a rotation direction thereof is the windward side thereof, and a side of the at least one blade 722 away from the rotation direction thereof is the leeward side thereof.

In some embodiments, as shown in FIG. 6 and FIG. 1, a radial distance between an end of the first edge portion 7221 near the third edge portion 7223 and the axis of the connecting portion 721 is greater than a radial distance between an end of the first edge portion 7221 near the fourth edge portion 7224 and the connecting portion 721. In this way, a gap between the blade 722 and a frame of the air outlet 63 ca be reduced, so that air leakage at the gap is reduced, an air outlet quantity of the fan 70 is increased, an air outlet efficiency of the air conditioner 1000 is improved, and operation power consumption of the air conditioner 1000 is reduced.

In some embodiments, by increasing a radial size of a position of the first edge portion 7221 of the blade 722 near the third edge portion 7223, the radial distance between the end of the first edge portion 7221 near the third edge portion 7223 and the axis of the connecting portion 721 can be greater than the radial distance between the end of the first edge portion 7221 near the fourth edge portion 7224 and the connecting portion 721. In this way, a contact area of the blade 722 and the airflow is also increased, which is beneficial to increasing the air outlet quantity of the air conditioner 1000. It is also possible to reduce vortexes and pressure pulsation at the at least one blade 722 caused by viscous resistance formed between gas and solid at the first edge portion 7221 and the fourth edge portion 7224 and a thickness of the at least one blade 722, thus improving flocculation at a surface of the at least one blade 722 and wake on the leeward side thereof, improving an aerodynamic efficiency of the fan 70, and reducing the noise generated when the fan 70 runs.

In some embodiments, as shown in FIG. 6, the first edge portion 7221 includes a first sub-edge portion 72211, the first sub-edge portion 72211 being arranged at an end of the first edge portion 7221 close to the third edge portion 7223. The first edge portion 7221 is connected to an end of the third edge portion 7223 away from the connecting portion 721 via the first sub-edge portion 72211.

In some embodiments, the first edge portion 7221 further includes a second sub-edge portion 72212, the second sub-edge portion 72212 being arranged at an end of the first edge portion 7221 close to the fourth edge portion 7224. The first edge portion 7221 is connected to an end of the fourth edge portion 7224 away from the connecting portion 721 via the second sub-edge portion 72212.

In some embodiments, the first edge portion 7221 further includes a third sub-edge portion 72213. The third sub-edge portion 72213 is arranged between the first sub-edge portion 72211 and the second sub-edge portion 72212, and is connected to the first sub-edge portion 72211 and the second sub-edge portion 72212 respectively.

In some embodiments, compared to conventional blades, when a radial size of the first edge portion 7221 is increased, a radial size of the second sub-edge portion 72212 may be kept unchanged, or the radial size of the second sub-edge portion 72212 may be reduced, or the radial size of the second sub-edge portion 72212 may be increased, and a radial size of the first sub-edge portion 72211 is increased accordingly, so that a distance between the first sub-edge portion 72211 and the axis of the connecting portion 721 is greater than a distance between the second sub-edge portion 72212 and the axis of the connecting portion 721.

In some embodiments, the first sub-edge portion 72211 includes a first end, the first end being arranged on a side of the first sub-edge portion 72211 proximate to the third edge portion 7223. The first sub-edge portion 72211 is connected to an end of the third edge portion 7223 away from the connecting portion 721 by the first end.

In some embodiments, the first sub-edge portion 72211 further includes a second end, the second end being arranged on a side of the first sub-edge portion 72211 distal from the third edge portion 7223. The first sub-edge portion 72211 is connected to the third sub-edge portion 72213 by the second end.

In some embodiments, the second sub-edge portion 72212 includes a third end, the third end being arranged on a side of the second sub-edge portion 72212 proximate to the fourth edge portion 7224. The second sub-edge portion 72212 is connected to an end of the fourth edge portion 7224 away from the connecting portion 721 by the third end.

In some embodiments, the second sub-edge portion 72212 further includes a fourth end, the fourth end being arranged on a side of the second sub-edge portion 72212 distal from the fourth edge portion 7224. The second sub-edge portion 72212 is connected to the third sub-edge portion 72213 by the fourth end.

It should be noted that, by providing the third sub-edge portion 72213 between the first sub-edge portion 72211 and the second sub-edge portion 72212, contact resistance of air caused by a large abrupt change of the radial size from the first sub-edge portion 72211 to the second sub-edge portion 72212 can be reduced, and an air outlet efficiency of the fan blade 72 is improved.

In some embodiments, a plane perpendicular to an axis of the fan blade 72 is defined as a cross section thereof, then at least one of a projection of the first sub-edge portion 72211 on the cross section and a projection of the second sub-edge portion 72212 on the cross section is an arc structure.

For example, if the projection of the first sub-edge portion 72211 on the cross section is a first circular arc, and the projection of the second sub-edge portion 72212 on the cross section is a second circular arc, circle centers of the first circular arc and the second circular arc are coincident and are located at an intersection of the axis of the fan blade 72 and the cross section.

In some embodiments, a distance between the first end of the first sub-edge portion 72211 and the axis of the connecting portion 721 is the same as a distance between the second end of the first sub-edge portion 72211 and the axis of the connecting portion 721, and a distance between the third end of the second sub-edge portion 72212 and the axis of the connecting portion 721 is the same as a distance between the fourth end of the second sub-edge portion 72212 and the axis of the connecting portion 721.

For another example, the projection of the second sub-edge portion 72212 on the cross section is a second circular arc, and the projection of the first sub-edge portion 72211 on the cross section is an arc structure.

In some embodiments, a radial size of the projection of the first sub-edge portion 72211 on the cross section of the fan blade 72 increases in a direction from the second end to the first end. That is, the distance between the first end of the first sub-edge portion 72211 and the axis of the connecting portion 721 is greater than the distance between the second end and the axis of the connecting portion 721.

For another example, the projection of the second sub-edge portion 72212 on the cross section is an arc structure, and the projection of the first sub-edge portion 72211 on the cross section is a first circular arc.

In some embodiments, a radial size of the projection of the second sub-edge portion 72212 on the cross section of the fan blade 72 increases in a direction from the third end to the fourth end. That is, the distance between the third end of the second sub-edge portion 72212 and the axis of the connecting portion 721 is smaller than the distance between the fourth end and the axis of the connecting portion 721.

In some embodiments, as shown in FIG. 5, the casing 60 further includes an air guide portion 64, and the air guide portion 64 defines the air outlet 63.

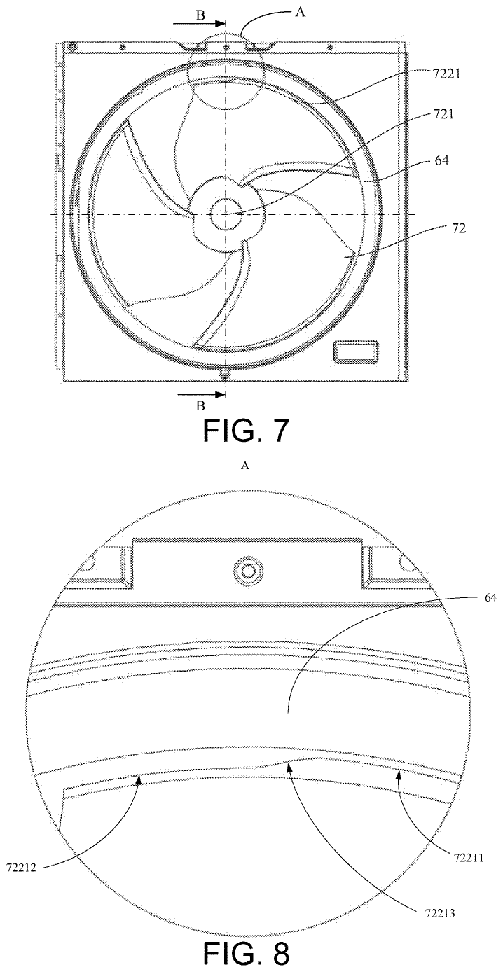

In some embodiments, in the case of mounting the fan blade 72, as shown in FIG. 7, at least part of the fan blade 72 is arranged at the air outlet 63.

In some embodiments, a difference between a radial size of the air guide portion 64 (e.g., a radius of the air guide portion 64) and the radial size of the first sub-edge portion 72211 of the first edge portion 7221 is less than a difference between the radial size of the air guide portion 64 and the radial size of the second sub-edge portion 72212. Therefore, an effective area of the fan blade 72 can be increased, a leakage area and an air leakage amount of a gap between the at least one blade 722 and the air guide portion 64 are reduced, an air outlet quantity and an aerodynamic efficiency of the fan blade 72 are improved, and the noise generated when the fan 70 operates is reduced.

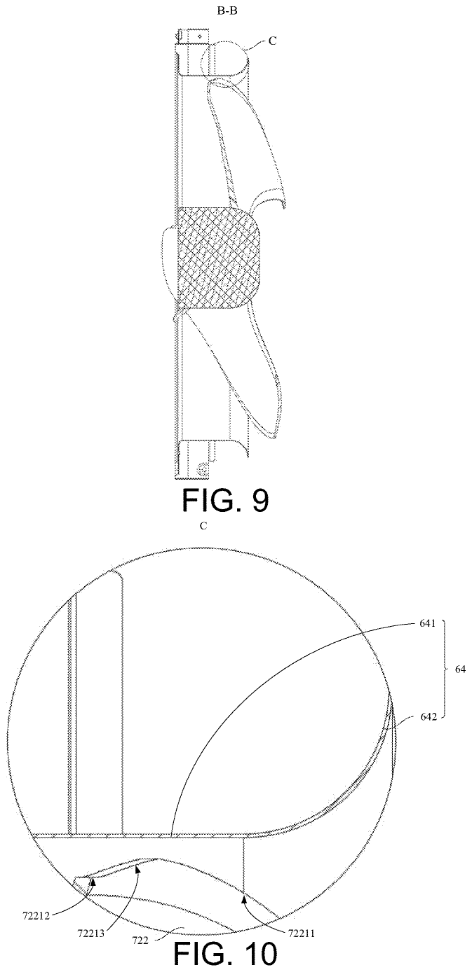

In some embodiments, as shown in FIG. 9 and FIG. 10, the air guide portion 64 includes a first sub-air guide portion 641, which is arranged around the air outlet 63 and located on a side of the air guide portion 64 away from the mounting cavity 61.

In some embodiments, the air guide portion 64 includes a second sub-air guide portion 642, which is connected to the first sub-air guide portion 641 and is located on a side of the air guide portion 64 close to the mounting cavity 61.

In some embodiments, a radial size of the second sub-air guide portion 642 increases in the direction from a side thereof close to the first sub-air guide portion 641 to a side thereof away from the first sub-air guide portion 641, so that the airflow can smoothly flow through the air outlet 63, an air inlet amount and an air outlet amount at the air outlet 63 are increased, and noise generated when the airflow flows is reduced.

In some embodiments, in an axial direction of the air guide portion 64, the second sub-edge portion 72212 is located inside the air guide portion, that is, a rear side part of the fan blade 72 is located between the air guide portion 64 and the outdoor heat exchanger 30, that is, a rear side of the fan blade 72 protrudes rearwards relative to the air guide portion 64. This is beneficial to reducing an axial size of the air guide portion 64, thereby saving manufacturing materials.

In some embodiments, as shown in FIG. 10, in an axial direction of the fan blade 72, the second sub-edge portion 72212 and the third sub-edge portion 72213 of the at least one blade 722 are arranged in the air outlet 63 defined by the first sub-air guide portion 641, for example. That is, projections of the second sub-edge portion 72212 and the third sub-edge portion 72213 along the radial direction thereof may be located on the first sub-air guide portion 641. A part of the first sub-edge portion 72211 of the at least one blade 722 close to the third edge portion 7223 is located between the air guide portion 64 and the outdoor heat exchanger 30, that is, the first sub-edge portion 72211 extends, for example, from the first sub-air guide portion 641 to the second sub-air guide portion 642 or to a region between the air guide portion 64 and the outdoor heat exchanger 30.

In some embodiments, a difference between an inner diameter of the air guide portion 64 (e.g., radius of the air guide portion 64) and a distance between the second sub-edge portion 72212 and the axis of the connecting portion 721 is, for example, any value in [6 mm, 12 mm]. For example, the difference is any value in [6 mm, 7 mm]. For another example, the difference is any value in [7 mm, 9 mm]. For another example, the difference is any value in [9 mm, 12 mm]. This facilitates the positioning and mounting of the fan blade 72 and the air guide portion 64.

In some embodiments, a difference between a distance between the first sub-edge portion 72211 and the axis of the connecting portion 721 and a distance between the second sub-edge portion 72212 and the axis of the connecting portion 721 may be any value in [2 mm, 20 mm]. For example, the difference is any value in [2 mm, 5 mm]. For another example, the difference is any value in [5 mm, 10 mm]. For another example, the difference is any value of [10 mm, 15 mm]. For another example, the difference is any value in [15 mm, 20 mm].

In some embodiments, the distance between the first sub-edge portion 72211 and the axis of the connecting portion 721 is smaller than the inner diameter of the air guide portion 64, so that a difference between the inner diameter of the air guide portion 64 and the distance between the first sub-edge portion 72211 and the axis of the connecting portion 721 can be, for example, any value of [2 mm, 4 mm]. For example, the difference is any value of [2 mm, 3 mm]. For another example, the difference is any value of [3 mm, 4 mm]. Therefore, an area of the fan blade 72 can be increased, air leakage can be reduced, and contact friction resistance between the fan blade 72 and the air guide portion 64 during rotation can be avoided.

In some embodiments, in a part of the first sub-edge portion 72211 corresponding to the first sub-air guide portion 641, the distance between the first sub-edge portion 72211 and the axis of the connecting portion 721 is smaller than an inner diameter of the first sub-air guide portion 641. For example, a difference between the inner diameter of the first sub-air guide portion 641 and the distance between the first sub-edge portion 72211 and the axis of the connecting portion 721 can be, for example, any value of [2 mm, 4 mm]. For example, the difference is any value of [2 mm, 3 mm]. For another example, the difference is any value of [3 mm, 4 mm]. Therefore, contact friction resistance between the fan blade 72 and the first sub-air guide portion 641 during rotation can be avoided.

In a part of the first sub-edge portion 72211 corresponding to the second sub-air guide portion 642, the distance between the first sub-edge portion 72211 and the axis of the connecting portion 721 is smaller than an inner diameter of the second sub-air guide portion 642. For example, a difference between the inner diameter of the second sub-air guide portion 642 and the distance between the first sub-edge portion 72211 and the axis of the connecting portion 721 can be, for example, any value of [2 mm, 4 mm]. For example, the difference is any value of [2 mm, 3 mm]. For another example, the difference is any value of [3 mm, 4 mm]. Therefore, contact friction resistance between the fan blade 72 and the second sub-air guide portion 642 during rotation can be avoided.

In some embodiments, the distance between the first sub-edge portion 72211 and the axis of the connecting portion 721 is larger than or equal to the inner diameter of the first sub-air guide portion 641. For example, in the part of the first sub-edge portion 72211 corresponding to the second sub-air guide portion 642, the distance between the first sub-edge portion 72211 and the axis of the connecting portion 721 is larger than or equal to the inner diameter of the first sub-air guide portion 641.

In some embodiments, in the case where at least part of the first sub-edge portion 72211 is located between the second sub-air guide portion 642 and the outdoor heat exchanger 30, a distance between the part of the first sub-edge portion 72211 and the axis of the connecting portion 721 is greater than or equal to a maximum radial size of the second sub-air guide portion 642.

In some embodiments, a curve of the third sub-edge portion 72213 includes, for example, at least one of a first curve y1, a second curve y2, or a third curve y3.

In the case where the curve of the third sub-edge portion 72213 includes two of the first curve y1, the second curve y2, and the third curve y3, the third sub-edge portion 72213 satisfies the following conditions:
along a direction from the first sub-edge portion 72211 to the second sub-edge portion 72212, the third sub-edge portion 72213 is formed by sequentially connecting the first curve y1 and the second curve y2, and an end of the first curve y1 away from the second curve y2 is connected to the first sub-edge portion 72211; or
along the direction from the first sub-edge portion 72211 to the second sub-edge portion 72212, the third sub-edge portion 72213 is formed by sequentially connecting the first curve y1 and the third curve y3, and an end of the first curve y1 away from the third curve y3 is connected to the first sub-edge portion 72211; or
along the direction from the first sub-edge portion 72211 to the second sub-edge portion 72212, the third sub-edge portion 72213 is formed by sequentially connecting the second curve y2 and the third curve y3, and an end of the second curve y2 away from the third curve y3 is connected to the first sub-edge portion 72211.

In some other embodiments, the curve of the third sub-edge portion 72213 includes the first curve y1, the second curve y2, and the third curve y3. Along the direction from the first sub-edge portion 72211 to the second sub-edge portion 72212, the third sub-edge portion 72213 is formed by sequentially connecting the first curve y1, the second curve y2 and the third curve y3, the end of the first curve y1 away from the second curve y2 is connected to the first sub-edge portion 72211, an end of the third curve y3 away from the second curve y2 is connected to the second sub-edge portion 72212, and the first curve y1 is connected to the third curve y3 through the second curve y2.

In this way, air resistance at the third sub-edge portion 72213 can be reduced, and a reduction of overall resistance of the fan 70 during rotation is facilitated, thereby improving the air outlet efficiency of the fan 70.

In this way, the resistance generated at the third sub-edge portion 72213 during the rotation of the at least one blade 722 along an axis thereof due to a large change of the radial sizes of the first sub-edge portion 72211 and the second sub-edge portion 72212 may be reduced.

In some exemplary embodiments, a shape of the first curve is defined by:

$${y}_{1} = - 0.0003 \times {x}_{1}^{3} + 0.0022 \times {x}_{1}^{2} + 0.025 \times {x}_{1} - 0.0017 ;$$

where 0.666774≤x₁≤10.84265;
a shape of the second curve is defined by:

$${y}_{2} = - 3 \times 1 {0}^{- 7} \times {x}_{2}^{5} + 5 \times 1 {0}^{- 5} \times {x}_{2}^{4} - 0.0034 \times {x}_{2}^{3} + 0.102 \times {x}_{2}^{2} - 1.24 \; 75 \times {x}_{2} + 5.3 \; 635 ;$$

where 10.84265≤x₂≤49.906286083;
a shape of the third curve is defined by:

$${y}_{3} = - 0.0006 \times {x}_{3}^{3} + 0.10004 \times {x}_{3}^{2} + 5.2005 \times {x}_{3} - 84.801 ;$$

where 49.906286083≤x₃≤58.208570544.

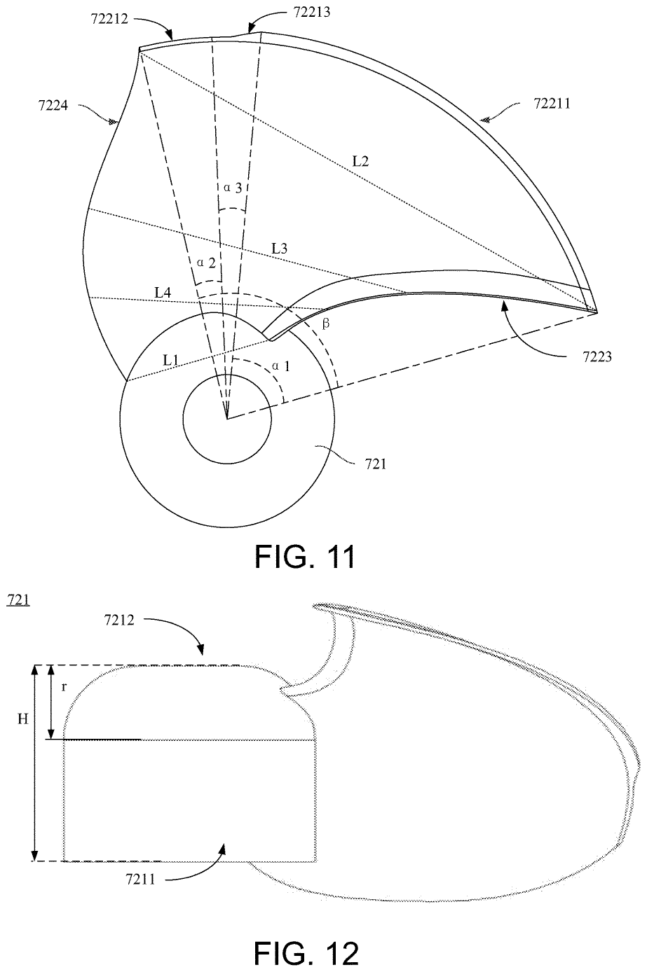

In some embodiments, as shown in FIG. 11, along the axial direction of the fan blade 72, a perpendicular projection of the first edge portion 7221 on the cross section of the fan blade 72 is defined as a first arc; an included angle formed by connection lines between two ends of the first arc and the axis of the fan blade 72 is defined as a first arc center angle β; an included angle at a corresponding axis of a perpendicular projection of the first sub-edge portion 72211 on the cross section of the fan blade 72 is defined as a first sub-arc center angle α1; an included angle at a corresponding axis of a perpendicular projection of the second sub-edge portion 72212 on the cross section of the fan blade 72 is defined as a second sub-arc center angle α2.

A ratio of the first sub-arc center angle α1 to the first arc center angle β is any value in the range of [76%, 81%]. For example, the ratio of the first sub-arc center angle α1 to the first arc center angle β may be 76%, 77%, 78%, 79%, 80%, or 81%.

A ratio of the second sub-arc center angle α2 to the first arc center angle β is any value in the range of [13%, 18%]. For example, the ratio of the second sub-arc center angle α2 to the first arc center angle β may be 13%, 14%, 15%, 16%, 17%, or 18%.

In some embodiments, an included angle at a corresponding axis of a perpendicular projection of the third sub-edge portion 72213 on the cross section of the fan blade 72 is defined as a third sub-arc center angle α2, and a ratio of the third sub-arc center angle α3 to the first arc center angle β is any value in the range of [4%, 8%]. For example, the ratio of the third sub-arc center angle α3 to the first arc center angle β may be 4%, 5%, 6%, 7%, or 8%.

In this way, extension lengths of the first sub-edge portion 72211, the third sub-edge portion 72213, and the second sub-edge portion 72212 can be obtained.

In some embodiments, under the condition that the ratio of the first sub-arc center angle α1 to the first arc center angle β is 78.85%, the ratio of the second sub-arc center angle α2 to the first arc center angle β is 15.35%, and the ratio of the third sub-arc center angle α3 to the first arc center angle β is 5.8%, the lengths of the first sub-edge portion 72211, the third sub-edge portion 72213, and the second sub-edge portion 72212 are designed and the corresponding fan blade 72 is manufactured, so that the fan blade 72 has a good effect of increasing the air quantity and a good effect of reducing the air noise.

In some embodiments, an element chord length of the at least one blade 722 is defined as a length of a connection line between a position on the third edge portion 7223 and a position on the fourth edge portion 7224 at the same length. In a direction from the second edge portion 7222 to the first edge portion 7221, the element chord length of the at least one blade 722 is increased and then decreased, which is beneficial to improving an air supply efficiency of the fan blade 72 and reducing air supply noise thereof.

As shown in FIG. 11, in a direction from the connecting portion 721 towards the first edge portion 7221, an element chord length of a connection line of intersections of the second edge portion 7222 with the third edge portion 7223 and the fourth edge portion 7224 is defined as a 0% element chord length L1 of the at least one blade 722; an element chord length of a connection line of intersections of the first edge portion 7221 with the third edge portion 7223 and the fourth edge portion 7224 is defined as a 100% element chord length L1 of the at least one blade 722; a connection line of positions of 50% of lengths of the third edge portion 7223 and the fourth edge portion 7224 is defined as a 50% element chord length L3 of the at least one blade 722; a connection line of positions of 25% of the lengths of the third edge portion 7223 and the fourth edge portion 7224 is defined as a 25% element chord length L4 of the at least one blade 722; a connection line of positions of 75% of the lengths of the third edge portion 7223 and the fourth edge portion 7224 is defined as a 75% element chord length L5 of the blade 722.

In some embodiments, shape and sizes of the third edge portion 7223 and the fourth edge portion 7224 of the at least one blade 722 satisfy: L3>L5>L2 and L3>L4>L1, which is beneficial to improving the air supply efficiency of the fan blade 72 and reducing the air supply noise thereof.

In some embodiments, the curve of the third edge portion 7223 of the at least one blade 722 may include a fourth curve y4 and a fifth curve y5 which are sequentially connected to form the third edge portion 7223 along the direction from the second edge portion 7222 to the first edge portion 7221.

A shape of the fourth curve is defined by:

$${y}_{4} = - 1 \times 1 {0}^{- 5} \times {x}_{4}^{6} + 0.02 \times {x}_{4}^{5} - 12.76 \times {x}_{4}^{4} + 4339.4 \times {x}_{4}^{3} - 829987 \times {x}_{4}^{2} + 8 \times 1 {0}^{7} \times {x}_{4} - 4 \times 1 {0}^{9} , ( 247.0999234 \leq {x}_{4} \leq 264.55928 \; 76 ) ;$$

a shape of the fifth curve is defined by:

$${y}_{5} = 3 \times 1 {0}^{- 6} \times {x}_{5}^{6} - 0.004 \times {x}_{5}^{5} + 2.5565 \times {x}_{5}^{4} - 862.89 \times {x}_{5}^{3} + 163802 \times {x}_{5}^{2} - 2 \times 1 {0}^{7} \times {x}_{5} + 7 \times 1 {0}^{8} , ( 245.7355578 \leq {x}_{5} \leq 264.5592876 ) .$$

A part between the intersection of the 50% element chord length of the third edge portion 7223 and the second edge portion 7222 may be set as the curve y4, and a part between the intersection of the 50% element chord length of the third edge portion 7223 and the first edge portion 7221 may be set as the curve y5.

In some embodiments, as shown in FIG. 12, the connecting portion 721 further includes a first sub-connecting portion 7211, and the first sub-connecting portion 7211 is arranged near the mounting cavity 61.

In some embodiments, the connecting portion 721 further includes a second sub-connecting portion 7212, and the second sub-connecting portion 7212 is arranged away from the mounting cavity 61 and connected to the first sub-connecting portion 7211.

In some embodiments, a size of the connecting portion 721 along the axial direction of the fan blade 72 is defined as H which is, for example, 85 mm.

A maximum size of the second sub-connecting portion 7212 in the axial direction of the fan blade 72 is defined as r which is, for example, 48.87 mm.

In some embodiments, the air guide portion 64 and the casing 60 are made of metal materials, for example, iron alloy. The fan blade 72 is made of, for example, polypropylene or acrylonitrile butadiene styrene (ABS) plastic.

In some embodiments, a size of the air guide portion 64 along the axial direction thereof is set to be 120 mm, a diameter of the air guide portion 64 is set to be 620 mm, the at least one blade 722 includes three blades 722, and a diameter of the fan blade 72 is set to be 600 mm.

Before optimization, a static pressure of the fan 70 and the air guide portion 64 is 45 Pa when the rotating speed is 730 rpm, power consumption of the fan 70 is 176.5 W, and the air outlet quantity at the air outlet 63 is 5480 m³/h, that is, a static pressure efficiency of the fan 70 before optimization is 38%.

After optimization, the static pressure of the fan 70 and the air guide portion 64 is 45 Pa when the rotating speed is 730 rpm, the power consumption of the fan 70 is 165.4 W, and the air outlet quantity at the air outlet 63 is 5490 m³/h, that is, the static pressure efficiency of the fan 70 after optimization is 40%.

It can be learned from the above parameters that by optimizing the fan 70 and the air guide portion 64, the air outlet quantity of the fan 70 is increased at the same rotating speed, the air outlet efficiency is improved, the power consumption is reduced, and the air noise is reduced.

TABLE 1

| | Before optimization [symbol] | | | After optimization [symbol] | | |
|---|---|---|---|---|---|---|
| Rotating | Air | Power | | Air | Power | |
| speed/ | quantity | consumption | Noise dB | quantity | consumption | Noise dB |
| rpm [symbol] | m³/h [symbol] | W [symbol] | (A) [symbol] | m³/h [symbol] | W [symbol] | (A) [symbol] |
| 300 [symbol] | 1802 [symbol] | 80 [symbol] | 30 [symbol] | 1820 [symbol] | 76 [symbol] | 29 [symbol] |
| 450 [symbol] | 2835 [symbol] | 67 [symbol] | 39 [symbol] | 2864 [symbol] | 64 [symbol] | 38 [symbol] |
| 540 [symbol] | 3455 [symbol] | 81 [symbol] | 44 [symbol] | 3490 [symbol] | 77 [symbol] | 43 [symbol] |
| 660 [symbol] | 4282 [symbol] | 124 [symbol] | 50 [symbol] | 4325 [symbol] | 118 [symbol] | 48 [symbol] |
| 840 [symbol] | 5522 [symbol] | 242 [symbol] | 57 [symbol] | 5577 [symbol] | 230 [symbol] | 55 [symbol] |

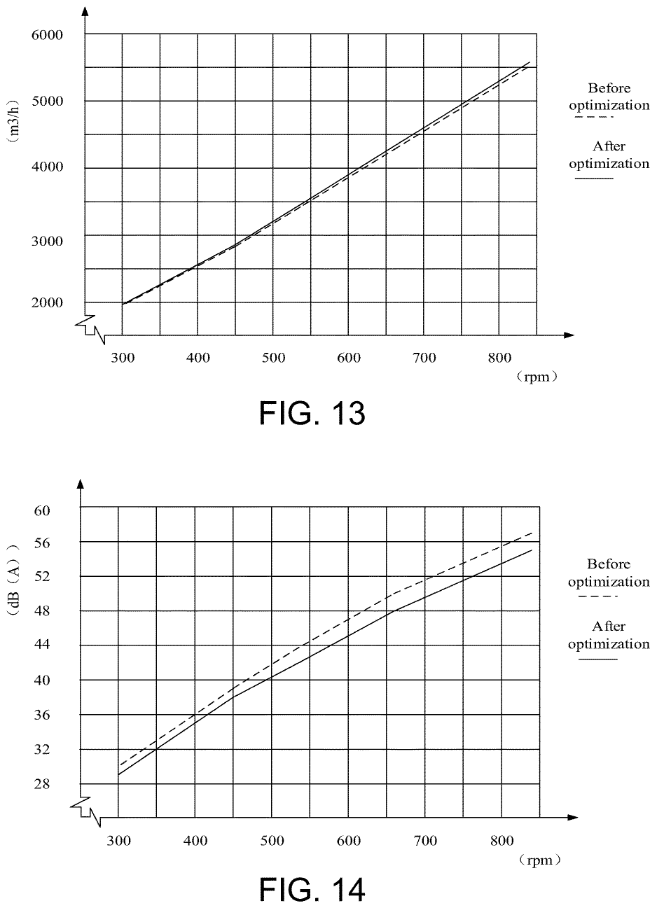

Table 1 is a comparative analysis table of the parameters of the fan 70 before and after optimization, and it can be known from table 1 and FIG. 13 that the air quantity is improved to a certain extent under the condition that the rotating speed of the fan 70 after optimization is the same as that of the fan 70 before optimization.

For example, when the rotating speed is 300 rpm, the air quantity of the fan 70 before optimization is 1802 m³/h, the air quantity of the fan 70 after optimization is 1820 m³/h, and the air quantity of the fan 70 is increased.

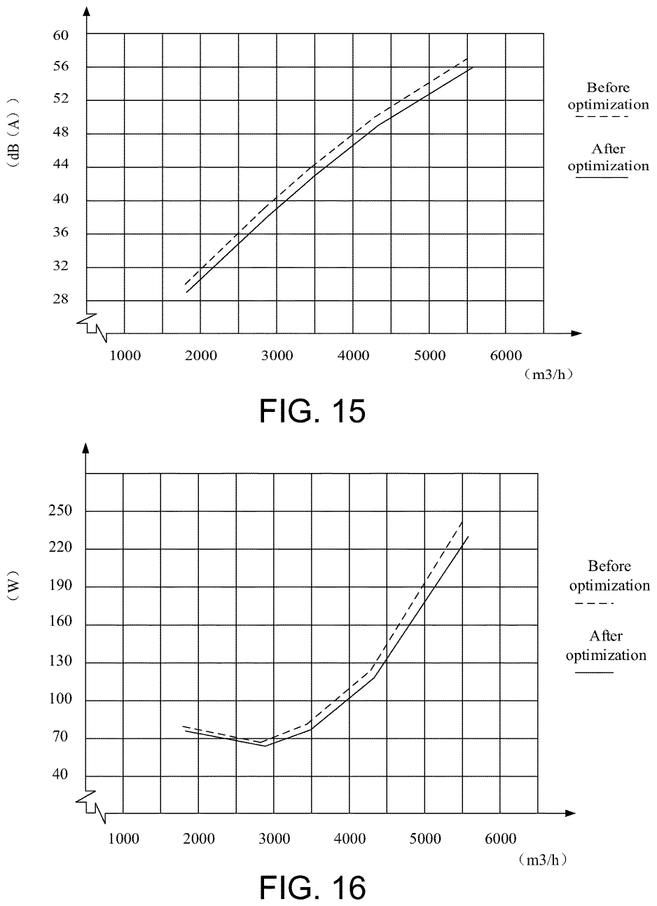

As can be seen from table 1, FIG. 14 and FIG. 15, when the rotating speed is the same, the noise of the fan 70 after optimization is reduced by any value of, for example, [1 dB (A), 3 dB (A)] compared with the noise of the fan 70 before optimization; under the condition of the same air quantity, the noise of the fan 70 after optimization is reduced by any value of [1 dB (A), 2 dB (A)], for example, compared with the noise of the fan 70 before optimization, so that a noise reduction effect of the fan 70 is improved.

As can be seen from table 1 and FIG. 16, when the air quantity is the same, the power consumption of the fan 70 after optimization is reduced compared with the power consumption of the fan 70 before optimization. Under the condition that the air quantity exceeds 3500 m³/h, the power consumption of the fan 70 after optimization is reduced by 4 W or more compared with the fan 70 before optimization, and the power consumption of the fan 70 is reduced.

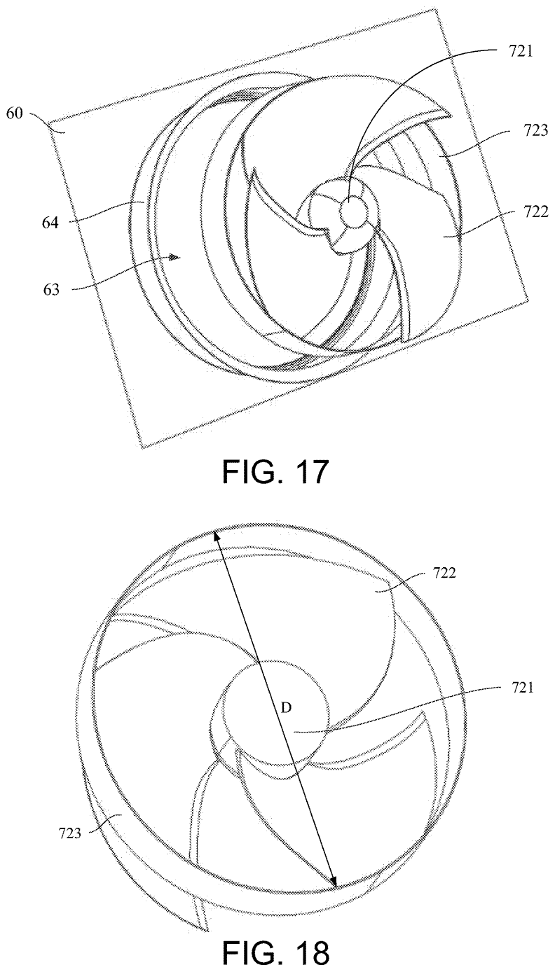

In some embodiments, as shown in FIG. 17 and FIG. 18, the fan blade 72 may further include an air blocking portion 723. The air blocking portion 723 is connected to the first edge portion 7221, and the at least one blade 722 and the connecting portion 721 are arranged on a side of the air blocking portion 723 close to the mounting cavity 61. The air blocking portion 723 may extend along a flow direction of the airflow, for example, the air blocking portion 723 extends along the axial direction of the fan blade 72 along a direction from the motor 71 towards the connecting portion 721. The air blocking portion 723 is spaced apart from the air guide portion 64 along the radial direction of the air guide portion 64, for example, the air blocking portion 723 is spaced apart from the first sub-air guide portion 641 along the radial direction of the first sub-air guide portion 641.

In some embodiments, a side of the air blocking portion 723 away from the mounting cavity 61 extends at least to a side of the at least one blade 722 away from mounting cavity 61 in the axial direction of the fan blade 72. The at least one blade 722 is connected to the air blocking portion 723 through the first edge portion 7221. In this way, in the process that the fan blade 72 rotates to drive the airflow to flow, the air blocking portion 723 can prevent the high-pressure airflow at a pressure surface of the at least one blade 722 from leaking through the gap between the first edge portion 7221 and the air guide portion 64, so that the air supply efficiency of the fan 70 is improved, and the operation power consumption of the fan 70 is reduced. The air blocking portion 723 may also reduce the airflow vortex and pressure pulsation of the at least one blade 722, thus reducing the noise of the fan 70. The air blocking portion 723 can also improve the flocculation and wake conditions of the surface of the at least one blade 722, thus improving the operation efficiency of the fan 70.

In some embodiments, as shown in FIG. 18, the diameter of the fan blade 72 is defined as D, and the diameter of the fan blade 72 may be any value of [500 mm, 700 mm], for example.

In some embodiments, along the radial direction of the fan blade 72, a distance between the air blocking portion 723 and the air guide portion 64 is defined as a first size 8, and the first size 8 and the diameter D of the fan blade 72 satisfy: D/70≤δ≤D/50. For example, the first size δ and the diameter D of the fan blade 72 satisfy at least one of: D/70≤δ<D/65, D/65≤δ≤D/55, or D/55≤δ≤D/50. Thus, normal mounting of the fan blade 72 can be ensured, and the air outlet quantity of the fan 70 can also be ensured. In some embodiments, the first size δ is, for example, D/60.

It should be noted that, when the first size δ is smaller than D/70, the gap between the air blocking portion 723 and the air guide portion 64 is smaller than a preset gap, which is inconvenient for mounting the fan blade 72. In the case where the first size δ is larger than D/50, an occupied area of the fan blade 72 relative to the air outlet 63 is small, and the air outlet quantity of the fan 70 is reduced.

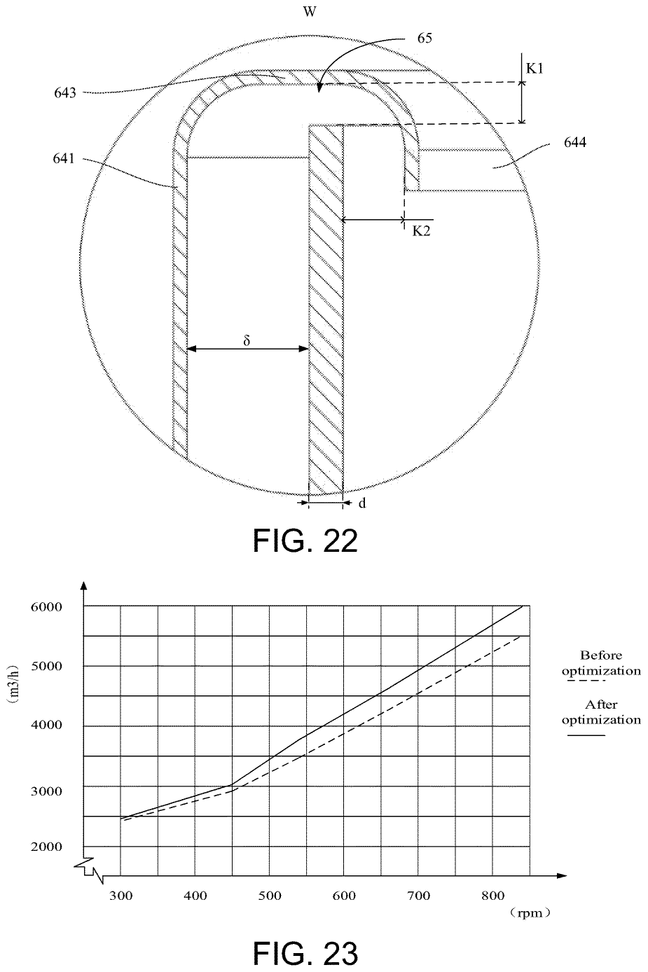

In some embodiments, as shown in FIG. 19 and FIG. 22, the air guide portion 64 further includes a mounting portion 65, and the mounting portion 65 is arranged on a side of the air guide portion 64 close to the mounting cavity 61 and configured to mount the air blocking portion 723. An end of the air blocking portion 723 away from the mounting cavity 61 is inserted into the mounting portion 65, so that the fan blade 72 and the air guide portion 64 can be positioned and mounted conveniently.

In some embodiments, as shown in FIG. 22, the air guide portion 64 further includes a third sub-air guide portion 643, and the third sub-air guide portion 643 is arranged close to the first sub-air guide portion 641 and connected to the first sub-air guide portion 641.

In some embodiments, the air guide portion 64 further includes a fourth sub-air guide portion 644, and the fourth sub-air guide portion 644 is arranged away from the first sub-air guide portion 641 and connected to the third sub-air guide portion 643.

Along the axial direction of the fan blade 72, an end of the first sub-air guide portion 641 close to the leeward side of the fan blade 72, the third sub-air guide portion 643 and the fourth sub-air guide portion 644 form the mounting portion 65, and an opening of the mounting portion 65 is arranged towards the windward side of the fan blade 72.

In some embodiments, as shown in FIG. 22, along the axial direction of the fan blade 72, a distance between the air blocking portion 723 and the third sub-air guide portion 643 is defined as a second size K₁, and the second size K₁ is, for example, any value in [0, 8].

In some embodiments, as shown in FIG. 22, along the radial direction of the air guide portion 64, a distance between the air blocking portion 723 and the fourth sub-air guide portion 644 is defined as a third size K₂, and the third size K₂ is, for example, any value in [0, 8].

Thus, during the rotation of the fan blade 72, the air blocking portion 723 can be prevented from contacting and rubbing the third sub-air guide portion 643 and the fourth sub-air guide portion 644, and resistance generated by the rubbing with the air guide portion 64 during the rotation of the fan blade 72 can be avoided.

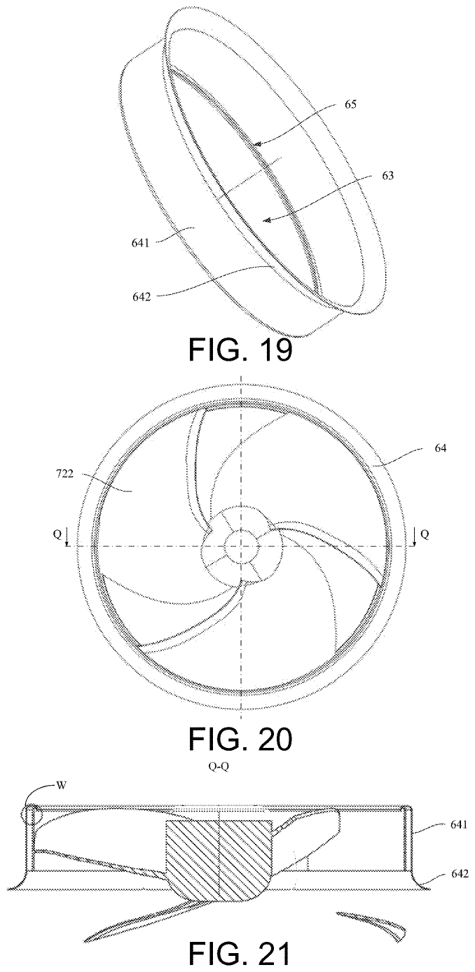

In some embodiments, as shown in FIG. 20, FIG. 21 and FIG. 22, in the radial direction of the fan blade 72, a thickness d of the air blocking portion 723 may be any value in [0.18, 0.258], for example. In this way, structural stability of the fan blade 72 can be guaranteed, a weight of the fan blade 72 can be reduced, and the air outlet efficiency of the fan 70 can be improved.

It should be noted that, when the thickness d of the air blocking portion 723 is smaller than 0.18, the air blocking portion 723 may be deformed by a centrifugal force generated during the rotation of the fan blade 72, so that the air blocking portion 723 may contact the air guide portion 64, thereby increasing rotation resistance and noise of the fan blade 72. Under the condition that the thickness d of the air blocking portion 723 is larger than 0.258, the weight of the fan blade 72 is larger than a preset weight, and the air outlet quantity and the air outlet efficiency of the fan 70 are reduced.

In some embodiments, the third sub-air guide portion 643 is connected to the first sub-air guide portion 641 through a rounded or chamfered structure, for example, so as to reduce the flow resistance of the airflow there.

In some embodiments, the third sub-air guide portion 643 is connected to the fourth sub-air guide portion 644 through a rounded corner structure or chamfered structure, for example, so as to reduce the flow resistance of the airflow there.

In some embodiments, the first size is set to 10 mm, the second and third sizes are set to 1 mm, and the thickness of the air blocking portion 723 is set to 2.5 mm.

Before optimization, the static pressure of the fan 70 is 45 Pa when the rotating speed is 730 rpm, the power consumption of the fan 70 is 176.5 W, and the air outlet quantity at the air outlet 63 is 5480 m³/h, that is, the static pressure efficiency of the fan 70 before optimization is 38%.

After optimization, the static pressure of the fan 70 is 45 Pa when the rotating speed is 730 rpm, the power consumption of the fan 70 is 178 W, and the air outlet quantity at the air outlet 63 is 5800 m³/h, that is, the static pressure efficiency of the fan 70 after optimization is 45%.

It can be learned from the above parameters that by optimizing the fan 70 and the air guide portion 64, the air outlet quantity of the fan 70 is increased at the same rotating speed, the air outlet efficiency is improved, the power consumption is reduced, and the air noise is reduced.

TABLE 2

| | Before optimization [symbol] | | | After optimization [symbol] | | |
|---|---|---|---|---|---|---|
| Rotating | Air | Power | | Air | Power | |
| speed/ | quantity | consumption | Noise dB | quantity | consumption | Noise dB |
| rpm [symbol] | m³/h [symbol] | W [symbol] | (A) [symbol] | m³/h [symbol] | W [symbol] | (A) [symbol] |
| 300 [symbol] | 1802 [symbol] | 40 [symbol] | 30 [symbol] | 1946.16 [symbol] | 42 [symbol] | 29 [symbol] |
| 450 [symbol] | 2835 [symbol] | 67 [symbol] | 39 [symbol] | 3061.8 [symbol] | 68.34 [symbol] | 38 [symbol] |
| 540 [symbol] | 3455 [symbol] | 81 [symbol] | 44 [symbol] | 3731.4 [symbol] | 82.62 [symbol] | 43 [symbol] |
| 660 [symbol] | 4282 [symbol] | 124 [symbol] | 50 [symbol] | 4624.56 [symbol] | 126.48 [symbol] | 49 [symbol] |
| 840 [symbol] | 5522 [symbol] | 242 [symbol] | 57 [symbol] | 5963.76 [symbol] | 246.84 [symbol] | 56 [symbol] |

Table 2 is a parameter analysis table before and after optimization of the element chord length of the at least one blade 722 of the fan 70 in the embodiment in which the fan blade 72 includes the air blocking portion 723, and it is understood from table 2 and FIG. 23 that the air quantity is improved to a certain extent under the condition that the rotating speed of the fan 70 after optimization is the same as that of the fan 70 before optimization.

For example, when the rotating speed is 300 rpm, the air quantity of the fan 70 before optimization is 1802 m³/h, the air quantity of the fan 70 after optimization is 1946.16 m³/h, and the air quantity of the fan 70 is increased.

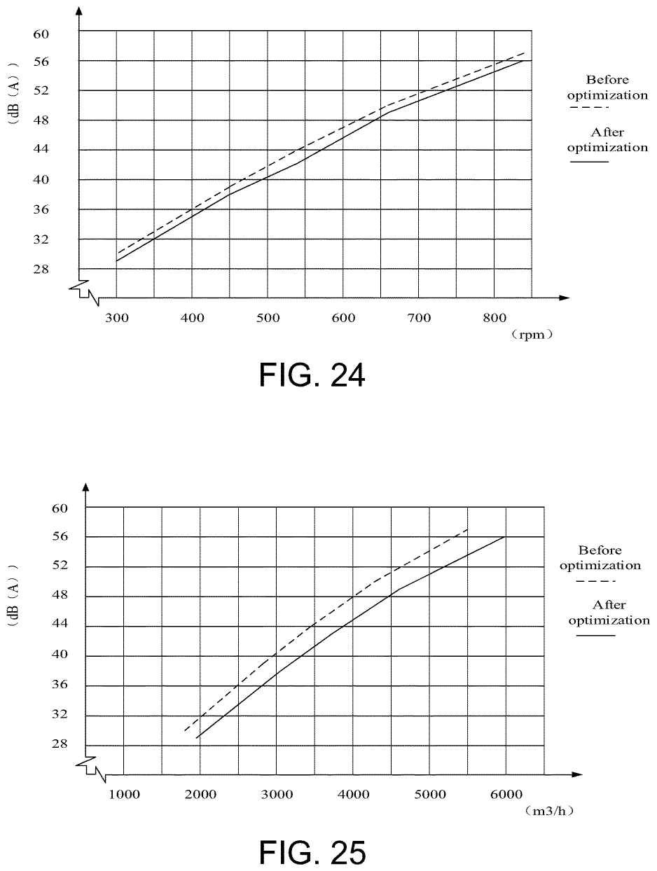

As can be seen from table 2, FIG. 24 and FIG. 25, under the condition of the same rotating speed, the noise of the fan 70 after optimization is reduced by any value of, for example, [1 dB (A), 2 dB (A)] compared with the noise of the fan 70 before optimization; under the condition of the same air quantity, the noise of the fan 70 after optimization is reduced by any value of [2 dB (A), 4 dB (A)], for example, compared with the noise of the fan 70 before optimization, so that a noise reduction effect of the fan 70 is improved.

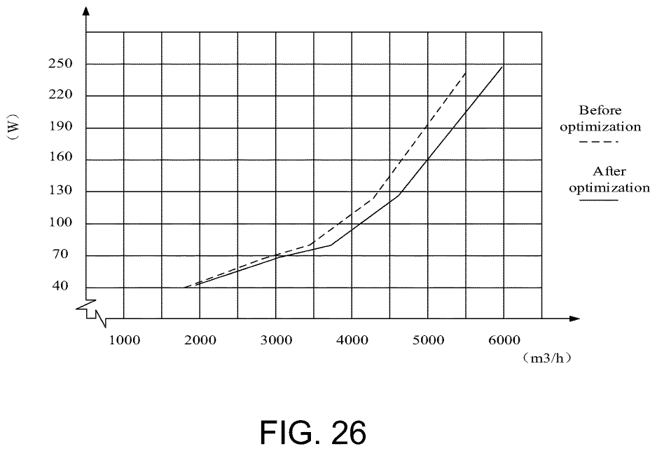

As can be seen from table 2 and FIG. 26, when the air quantity is the same, the power consumption of the fan 70 after optimization is reduced compared with the power consumption of the fan 70 before optimization. Under the condition that the air quantity exceeds 3500 m³/h, the power consumption of the fan 70 after optimization is reduced by 10W or more compared with the fan 70 before optimization, and the power consumption of the fan 70 is reduced.

For example, in the case where the air quantity is 5500 m³/h, the power consumption of the fan 70 before optimization is about 240 W, and the power consumption of the fan 70 after optimization is about 205 W. That is, under the condition that the air quantity is 5500 m³/h, the power consumption of the fan 70 after optimization is reduced by 35 W compared with the fan 70 before optimization, a reduction amplitude is 14.6%, and in this case, the fan 70 meets energy-saving requirements.

It should be noted that the fan 70 and the adaptive air guide portion 64 may be applied to the outdoor unit 200 or the indoor unit 300.

In some embodiments, an air conditioner is provided. The outdoor unit includes a casing. The casing includes a mounting cavity. The outdoor unit further includes a fan arranged in the mounting cavity. The fan includes a motor and a fan blade. The fan blade includes a connecting portion and at least one blade. The at least one blade is connected to an output portion of the motor through the connecting portion. The at least one blade includes a first edge portion arranged on a side of the at least one blade away from the connecting portion. The first edge portion includes a first sub-edge portion, a second sub-edge portion, and a third sub-edge portion. The first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion. A distance between an end of the first sub-edge portion that is close to the windward side of the at least one blade and an axis of the connecting portion is greater than a distance between an end of the second sub-edge portion that is close to the leeward side of the at least one blade and the axis of the connecting portion.

In some embodiments, the housing further includes an air guide portion which defines an air outlet, and in an axial direction of the air guide portion, the second sub-edge portion extends into the air guide portion.

In some embodiments, an air conditioner is provided. The outdoor unit includes a casing. The casing includes a mounting cavity. The outdoor unit further includes a fan arranged in the mounting cavity. The fan includes a motor and a fan blade. The fan blade includes a connecting portion and at least one blade. The at least one blade is connected to an output portion of the motor through the connecting portion. The at least one blade includes a first edge portion arranged on a side of the at least one blade away from the connecting portion. The first edge portion includes a first sub-edge portion, a second sub-edge portion, and a third sub-edge portion. The first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion. There exists a point on the first sub-edge portion, a distance from which to an axis of the connecting portion is greater than a distance from a point on the second sub-edge portion to the axis of the connecting portion.

In some embodiments, an air conditioner is provided. The outdoor unit includes a casing. The casing includes a mounting cavity. The outdoor unit further includes a fan arranged in the mounting cavity. The fan includes a motor and a fan blade. The fan blade includes a connecting portion and at least one blade. The at least one blade is connected to an output portion of the motor through the connecting portion. The at least one blade includes a first edge portion arranged on a side of the at least one blade away from the connecting portion. The first edge portion includes a first sub-edge portion, a second sub-edge portion, and a third sub-edge portion. The first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion. The third sub-edge portion extends toward the connecting portion in a direction from the first sub-edge portion to the second sub-edge portion.

In some embodiments, an air conditioner is provided. The outdoor unit includes a casing. The casing includes a mounting cavity. The outdoor unit further includes a fan arranged in the mounting cavity. The fan includes a motor and a fan blade. The fan blade includes a connecting portion and at least one blade. The at least one blade is connected to an output portion of the motor through the connecting portion. The at least one blade includes a first edge portion arranged on a side of the at least one blade away from the connecting portion. The first edge portion includes a first sub-edge portion, a second sub-edge portion, and a third sub-edge portion. The first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion. A distance between any point on the first sub-edge portion and the axis of the connecting portion is greater than a distance between any point on the second sub-edge portion and the axis of the connecting portion.

In some embodiments, an air conditioner is provided. The outdoor unit includes a casing. The casing includes a mounting cavity. The outdoor unit further includes a fan arranged in the mounting cavity. The fan includes a motor and a fan blade. The fan blade includes a connecting portion and at least one blade. The at least one blade is connected to an output portion of the motor through the connecting portion. The at least one blade includes a first edge portion arranged on a side of the at least one blade away from the connecting portion. The first edge portion includes a first sub-edge portion, a second sub-edge portion, and a third sub-edge portion. The first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion. A plane perpendicular to an axis of the fan blade is defined as a cross section of the fan blade, a projection of the first sub-edge portion on the cross section is a first circular arc, a projection of the second sub-edge portion on the cross section is a second circular arc, and the radius of the first circular arc is greater than the radius of the second circular arc.

In some embodiments, an air conditioner is provided. The outdoor unit includes a casing. The casing includes a mounting cavity. The outdoor unit further includes a fan arranged in the mounting cavity. The fan includes a motor and a fan blade. The fan blade includes a connecting portion and at least one blade. The at least one blade is connected to an output portion of the motor through the connecting portion. The at least one blade includes a first edge portion arranged on a side of the at least one blade away from the connecting portion. The first edge portion includes a first sub-edge portion, a second sub-edge portion, and a third sub-edge portion. The first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion. The first sub-edge portion includes a first end and a second end, and the second end of the first sub-edge portion is connected to one end of the third sub-edge portion. The second sub-edge portion includes a third end and a fourth end, and the fourth end of the second sub-edge portion is connected to the other end of the third sub-edge portion. A distance between the second end and the axis of the connecting portion is greater than a distance between the third end and the axis of the connecting portion.

The specific features of the air conditioner may be referred to the descriptions above for details, which are not repeated here.

It will be understood by those skilled in the art that the scope of the disclosure of the present disclosure is not limited to the particular embodiments described above, and that modifications and substitutions of certain elements of the embodiments may be made without departing from the spirit of the disclosure. The scope of the present disclosure is limited by the appended claims.

What is claimed is:

1. An air conditioner, comprising:
an outdoor unit comprising:
a casing comprising a mounting cavity; and
a fan arranged in the mounting cavity, wherein the fan comprises:
a motor; and
a fan blade, wherein the fan blade comprises a connecting portion and at least one blade, and the at least one blade is connected to an output portion of the motor through the connecting portion;
wherein the at least one blade comprises a first edge portion arranged on a side of the at least one blade away from the connecting portion, and the first edge portion comprises a first sub-edge portion, a second sub-edge portion, and a third sub-edge portion;
the first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion; and
a distance between an end of the first sub-edge portion that is close to the windward side of the at least one blade and an axis of the connecting portion is greater than a distance between an end of the second sub-edge portion that is close to the leeward side of the at least one blade and the axis of the connecting portion.

2. The air conditioner of claim 1, wherein a plane perpendicular to an axis of the fan blade is defined as a cross section of the fan blade, a projection of the first sub-edge portion on the cross section is a first circular arc, and a projection of the second sub-edge portion on the cross section is a second circular arc.

3. The air conditioner of claim 1, wherein
the first sub-edge portion comprises a first end and a second end, and the second end of the first sub-edge portion is connected to one end of the third sub-edge portion;
the second sub-edge portion comprises a third end and a fourth end, and the fourth end of the second sub-edge portion is connected to the other end of the third sub-edge portion; and
a plane perpendicular to an axis of the fan blade is defined as a cross section of the fan blade, a radial size of a projection of the first sub-edge portion on the cross section of the fan blade increases in a direction from the second end to the first end.

4. The air conditioner of claim 1, wherein
the first sub-edge portion comprises a first end and a second end, and the second end of the first sub-edge portion is connected to one end of the third sub-edge portion;
the second sub-edge portion comprises a third end and a fourth end, and the fourth end of the second sub-edge portion is connected to the other end of the third sub-edge portion; and
a plane perpendicular to an axis of the fan blade is defined as a cross section of the fan blade, a radial size of a projection of the second sub-edge portion on the cross section of the fan blade increases in a direction from the third end to the fourth end.

5. The air conditioner of claim 1, wherein
the first sub-edge portion comprises a first end and a second end, and the second end of the first sub-edge portion is connected to one end of the third sub-edge portion;
the second sub-edge portion comprises a third end and a fourth end, and the fourth end of the second sub-edge portion is connected to the other end of the third sub-edge portion;
a distance between the first end and the axis of the connecting portion is greater than or equal to a distance between the second end and the axis of the connecting portion; and
a distance between the third end and the axis of the connecting portion is less than or equal to a distance between the fourth end and the axis of the connecting portion.

6. The air conditioner of claim 1, wherein the third sub-edge portion comprises at least one of a first curve, a second curve, or a third curve.

7. The air conditioner of claim 6, wherein along a direction from the first sub-edge portion to the second sub-edge portion, the third sub-edge portion comprises the first curve, the second curve, and the third curve that are connected in sequence;
wherein an end of the first curve away from the second curve is connected to the first sub-edge portion, an end of the third curve away from the second curve is connected to the second sub-edge portion, and the first curve is connected to the third curve through the second curve.

8. The air conditioner of claim 6, wherein along a direction from the first sub-edge portion to the second sub-edge portion, the third sub-edge portion comprises the first curve and the second curve that are connected in sequence, and an end of the first curve away from the second curve is connected to the first sub-edge portion; or
along the direction from the first sub-edge portion to the second sub-edge portion, the third sub-edge portion comprises the first curve and the third curve that are connected in sequence, and an end of the first curve away from the third curve is connected to the first sub-edge portion; or
along the direction from the first sub-edge portion to the second sub-edge portion, the third sub-edge comprises the second curve and the third curve that are connected in sequence, and an end of the second curve away from the third curve is connected to the first sub-edge portion.

9. The air conditioner of claim 1, wherein the housing further comprises an air guide portion which defines an air outlet; and
in an axial direction of the air guide portion, the second sub-edge portion extends into the air guide portion.

10. The air conditioner of claim 9, wherein a difference between an inner diameter of the air guide portion and a distance between the second sub-edge portion and the axis of the connecting portion is any value in [6 mm, 12 mm].

11. The air conditioner according to claim 1, wherein a difference between a distance between the first sub-edge portion and the axis of the connecting portion and a distance between the second sub-edge portion and the axis of the connecting portion is any value in [2 mm, 20 mm].

12. The air conditioner of claim 1, wherein
a plane perpendicular to an axis of the fan blade is defined as a cross section of the fan blade, along an axial direction of the fan blade, a perpendicular projection of the first edge portion on the cross section of the fan blade is defined as a first arc;
an included angle formed by connection lines between two ends of the first arc and the axis of the fan blade is defined as a first arc center angle β;
an included angle formed by connection lines between two ends of a perpendicular projection of the third sub-edge portion on the cross section of the fan blade and the axis of the fan blade is defined as a third sub-arc center angle α3, and a ratio of the third sub-arc center angle α3 to the first arc center angle β is any value in [4%, 8%].

13. An air conditioner comprising:
an outdoor unit comprising:
a casing comprising a mounting cavity; and
a fan arranged in the mounting cavity, wherein the fan comprises:
a motor; and
a fan blade, wherein the fan blade comprises a connecting portion and at least one blade, and the at least one blade is connected to an output portion of the motor through the connecting portion;
wherein the at least one blade comprises a first edge portion arranged on a side of the at least one blade away from the connecting portion, and the first edge portion comprises a first sub-edge portion, a second sub-edge portion, and a third sub-edge portion;
the first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion; and
there exists a point on the first sub-edge portion, a distance from which to an axis of the connecting portion is greater than a distance from a point on the second sub-edge portion to the axis of the connecting portion.

14. The air conditioner of claim 13, wherein a plane perpendicular to an axis of the fan blade is defined as a cross section of the fan blade, a projection of the first sub-edge portion on the cross section is a first circular arc, and a projection of the second sub-edge portion on the cross section is a second circular arc.

15. The air conditioner of claim 14, wherein a center of the first circular arc and a center of the second circular arc are coincident.

16. The air conditioner of claim 13, wherein
the first sub-edge portion comprises a first end and a second end, and the second end of the first sub-edge portion is connected to one end of the third sub-edge portion;
the second sub-edge portion comprises a third end and a fourth end, and the fourth end of the second sub-edge portion is connected to the other end of the third sub-edge portion;
a distance between the first end and the axis of the connecting portion is greater than or equal to a distance between the second end and the axis of the connecting portion; and
a distance between the third end and the axis of the connecting portion is less than or equal to a distance between the fourth end and the axis of the connecting portion.

17. The air conditioner according to claim 13, wherein the third sub-edge portion comprises at least one of a first curve, a second curve, or a third curve.

18. The air conditioner of claim 13, wherein the housing further comprises an air guide portion which defines an air outlet; and
in an axial direction of the air guide portion, the second sub-edge portion extends into the air guide portion.

19. The air conditioner of claim 13, wherein
a plane perpendicular to an axis of the fan blade is defined as a cross section of the fan blade, along an axial direction of the fan blade, a perpendicular projection of the first edge portion on the cross section of the fan blade is defined as a first arc;
an included angle formed by connection lines between two ends of the first arc and the axis of the fan blade is defined as a first arc center angle β;
an included angle formed by connection lines between two ends of a perpendicular projection of the third sub-edge portion on the cross section of the fan blade and the axis of the fan blade is defined as a third sub-arc center angle α3, and a ratio of the third sub-arc center angle α3 to the first arc center angle β is any value in [4%, 8%].

20. An air conditioner, comprising:
an outdoor unit comprising:
a casing comprising a mounting cavity; and
a fan arranged in the mounting cavity, wherein the fan comprises:
a motor; and
a fan blade, wherein the fan blade comprises a connecting portion and at least one blade, and the at least one blade is connected to an output portion of the motor through the connecting portion;
wherein the at least one blade comprises a first edge portion arranged on a side of the at least one blade away from the connecting portion, and the first edge portion comprises a first sub-edge portion, a second sub-edge portion, and a third sub-edge portion;
the first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion; and
the third sub-edge portion extends toward the connecting portion in a direction from the first sub-edge portion to the second sub-edge portion.
